(19) United States
(12) Patent Application Publication
(10) Pub. No.: US 2006/0159464 A1
(43) Pub. Date: Jul. 20, 2006

(54) Method and apparatus for in-service monitoring of a regional undersea optical transmission system using COTDR

(76) Inventors: William David Cornwell, Hoole (GB); Henry Owen Edwards, Mold (GB); Stephen G. Evangelides JR., Red Bank, NJ (US); Jonathan A. Nagel, Brooklyn, NY (US); Nigel Hunt Taylor, Chester (GB); Glenn John Ahern, Englishtown, NJ (US); Stephen Arthur Hughes Smith, Chester (GB)

Correspondence Address: MAYER & WILLIAMS PC, 251 NORTH AVENUE WEST, 2ND FLOOR, WESTFIELD, NJ, 07090, US

(21) Appl. No.: 11/031,517

(22) Filed: Jan. 7, 2005

Related U.S. Application Data
(60) Provisional application No. 60/535,135, filed on Jan. 7, 2004.

(30) Foreign Application Priority Data
Apr. 20, 2001 (JP) 2001121883

(51) Int. Cl. H04B 10/00

(52) U.S. Cl. 398/169

(57) ABSTRACT

A method and apparatus is provided for obtaining status information concerning an optical transmission path. The method begins by generating a COTDR probe signal having a prescribed wavelength and transmitting optical traffic signals and the COTDR probe signal over an optical transmission path having a length corresponding to those used in regional undersea market applications. The prescribed wavelength of the COTDR probe signal is separated from wavelengths at which the optical traffic signals are located by a distance at least equal to a predetermined guard band. A backscattered and/or reflected portion of the COTDR probe signal in which status information concerning the optical path is embodied is received over the optical path. The backscattered and/or reflected portion of the COTDR probe signal is detected to obtain the status information.

### STATEMENT OF RELATED APPLICATIONS

This application claims the benefit of priority to U.S. Provisional Patent Appl. Ser. No. 60/535,135, filed Jan. 7, 2004, entitled “Line Fault Location Algorithm”.

This application is related to U.S. application Ser. No. 10/794,178 entitled “Method and Apparatus for Obtaining Status Information Concerning An In-Service Optical Transmission Line,” filed on Mar. 5, 2004.

This application is also related to U.S. application Ser. No. 10/870,327 entitled “Submarine Optical Transmission Systems having Optical Amplifiers of Unitary Design,” filed on Jun. 17, 2004.

### FIELD OF THE INVENTION

The present invention relates generally to optical transmission systems, and more particularly to the use of an arrangement to allow coherent optical time domain reflectometry (COTDR) to be used to detect faults in the optical transmission path of an optical transmission system consisting of multiple spans of fiber and optical amplifiers.

### BACKGROUND OF THE INVENTION

A typical long-range optical transmission system includes a pair of unidirectional optical fibers that support optical signals traveling in opposite directions. An optical signal is attenuated over long distances. Therefore, the optical transmission line will typically include repeaters that restore the signal power lost due to fiber attenuation and are spaced along the transmission line at some appropriate distance from one another. The repeaters include optical amplifiers. The repeaters also include an optical isolator that limits the propagation of the optical signal to a single direction.

In long-range optical transmission links it is important to monitor the health of the system. For example, monitoring can detect faults or breaks in the fiber optic cable, localized increases in attenuation due to sharp bends in the cable, or the degradation of an optical component. Amplifier performance must also be monitored. For long haul undersea cables there are two basic approaches to in-service monitoring: monitoring that is performed by the repeaters, with the results being sent to the shore station via a telemetry channel, and shore-based monitoring in which a special signal is sent down the line and is received and analyzed for performance data. Coherent optical time domain reflectometry (COTDR) is one shore-based technique used to remotely detect faults in optical transmission systems. In COTDR, an optical pulse is launched into an optical fiber and backscattered signals returning to the launch end are monitored. In the event that there are discontinuities such as faults or splices in the fiber, the amount of backscattering generally changes and such change is detected in the monitored signals. Backscattering and reflection also occur from discrete elements such as couplers, which create a unique signature. The link's health or performance is determined by comparing the monitored COTDR with a reference record. New peaks and other changes in the monitored signal level being indicative of changes in the fiber path, normally indicating a fault.

One complication that occurs when COTDR is used in a multi-span transmission line in which the individual spans are concatenated by repeaters is that the optical isolators located downstream from each repeater prevent the backscattered signal from being returned along the same fiber on which the optical pulse is initially launched. To overcome this problem each repeater includes a bidirectional coupler connecting that repeater to a similar coupler in the opposite-going fiber, thus providing an optical path for the backscattered light so that it can be returned to the COTDRunit. In most DWDM links employing such a return path there may also be a filter immediately following the coupler so that only the COTDR signal is coupled onto the return path, thus avoiding interference that would occur if the signals from one fiber were coupled onto the return path fiber) Thus, signals generated by the backscattering and reflection of a COTDR pulse launched on one fiber are coupled onto the opposite-going fiber to be returned to the COTDR unit for analysis.

The time between pulse launch and receipt of a backscattered signal is proportional to the distance along the fiber to the source of the backscattering, thus allowing the fault to be located. Accordingly, the duty cycle of the pulses must be greater than their individual round trip transit times in the transmission line to obtain an unambiguous return signal. To obtain high spatial resolution the pulses are typically short in duration (e.g., between a few and tens of microseconds) and high in intensity (e.g., tens of milliwatts peak power) to get a good signal to noise ratio.

The previously mentioned two features of the COTDR pulse, high power and low duty cycle, generally make COTDR unacceptable for use when the transmission system is in-service (i.e., when it is carrying customer traffic). This is because the high power COTDR pulses can interact with the channels supporting traffic via four wave mixing (FWM) or cross phase modulation (XPM). Moreover, XPM from the customer traffic channels can also broaden the COTDR pulse width enough to remove a significant amount of its energy out of the original signal bandwidth. Since the COTDR receiver has quite a narrow bandwidth, some of the power in the COTDR signal will be lost as it traverses the receiver, thereby lowering its optical signal-to-noise-ratio (OSNR) and significantly impairing the COTDR sensitivity. The problems caused by FWM and XPM can be alleviated by locating the COTDR at a wavelength that is sufficiently far from the nearest signal wavelength. The appropriate separation generally will depend on the specifics of the dispersion map, the system length and the customer traffic signal levels.

Another reason why it is problematic to use COTDR in-service is because the COTDR pulses give rise to gain fluctuations that cause transient behavior in the optical amplifiers. This in turn effects the signal carrying channels. In general this effect is known as cross gain coupling. The optical amplifiers generally use erbium as the active element to supply gain. The optical amplifiers treat the COTDR pulses as transients because the duty cycle of the COTDR pulses (for any transmission span of realistic length) is longer than the lifetime of the erbium ions in their excited state, which defines the characteristic response time of the amplifier. (Such transient behavior will also occur if Raman optical amplifiers or semiconductor optical amplifiers are employed, since they have characteristic lifetimes on the order of femtoseconds, and nanoseconds, respectively). For example, the round-trip travel time for a COTDR pulse in a 500 km transmission span is approximately 5 milliseconds, whereas the erbium lifetime is approximately 300 microseconds. Since the time between COTDR pulses is much greater than the response time of the optical amplifier, the presence of a COTDR pulse along with the traffic will cause transient behavior in the amplifier. The transient behavior of the optical amplifier caused by the COTDR pulse manifests itself as a reduction in gain and a change in gain tilt, which can adversely affect system performance.

### SUMMARY OF THE INVENTION

In accordance with the present invention, a method and apparatus is provided for obtaining status information concerning an optical transmission path. The method begins by generating a COTDR probe signal having a prescribed wavelength and transmitting optical traffic signals and the COTDR probe signal over an optical transmission path having a length corresponding to those used in regional undersea market applications. The prescribed wavelength of the COTDR probe signal is separated from wavelengths at which the optical traffic signals are located by a distance at least equal to a predetermined guard band. A backscattered and/or reflected portion of the COTDR probe signal in which status information concerning the optical path is embodied is received over the optical path. The backscattered and/or reflected portion of the COTDR probe signal is detected to obtain the status information.

In accordance with one aspect of the invention, the length of the optical transmission path is less than about 5,000 km.

In accordance with another aspect of the invention, the predetermined guard band is equal to or greater than about 200 GHz.

In accordance with another aspect of the invention, the COTDR probe signal is a pulsed signal.

In accordance with another aspect of the invention, the COTDR probe signal includes a saturating signal to reduce gain modulation.

### BRIEF DESCRIPTION OF THE DRAWINGS

FIG. 1 shows a simplified block diagram of a transmission system that employs a COTDR arrangement in accordance with the present invention.

FIG. 2 is a block diagram showing one embodiment of a COTDR arrangement constructed in accordance with the present invention.

FIG. 3 is graph showing the COTDR performance penalty versus the nearest data channel for system length of 1400 km.

FIG. 4 is a graph showing the effect of COTDR pulsing on the system Q penalty.

### DETAILED DESCRIPTION OF THE INVENTION

The present inventors have recognized that COTDR techniques may be employed in an undersea optical transmission system while the system is in-service if the transmission system is of the type directed to the so-called regional undersea market. The regional undersea market is approximately positioned between short-haul “repeater-less” (also known as the “festoon” market) and the long-haul transoceanic repeatered markets. Short-haul, or repeater-less systems employ links without powered in-line amplification (hence the term repeater-“less”). Short-haul links typically rely on high optical signal launch power from shore to overcome any inherent loss in the line. Repeater-less systems are generally limited to links of about 250 km in length. A maximum upper limit of 400-450 km is observed in practice because the line loss, which scales with distance, outstrips available line gain, the ability to launch more power into the line, and the ability of the system to resolve the received optical signal. By comparison, the long-haul undersea market segment, which encompasses system lengths in excess of about 5,000 km, employs very sophisticated transmission techniques to maximize bandwidth capacity and system reach.

The present invention overcomes the aforementioned problems and limitations of conventional COTDR arrangements by recognizing that the conditions under which in-service COTDR monitoring can be performed are particularly compatible with system lengths corresponding to those used in the regional undersea market. Under these conditions the primary difficulties that ordinarily arise when using COTDR in-service can be overcome. As previously noted, these problems include the degradation of the COTDR signal by the traffic-carrying signals as a result of nonlinear effects that cause spectral broadening and a consequent loss of coherence. In addition, the presence of the COTDR signal degrades the traffic-carrying signals, either through loss in the optical signal-to-noise ratio and/or by gain modulation effects.

Since the COTDR monitor of the present invention can be used in-service, it can locate faults such as pump degradations, localized fiber loss increases in a cable, fiber aging and loop back failures, as well as the faults resulting in loss of service, such as cable cuts and repeater faults. Through regular monitoring it should be possible to monitor the performance of both fibers and repeaters in the transmission path. Through regular monitoring it should also be possible to observe trends, with the objective of identifying or predicting potential faults before they occur. Since repeater telemetry is not required to locate pump failures and monitor amplifier performance, the complexity of the undersea plant is reduced. Moreover, the inventive COTDR monitoring technique has the advantage of providing additional information about fiber performance that is not available from repeater telemetry.

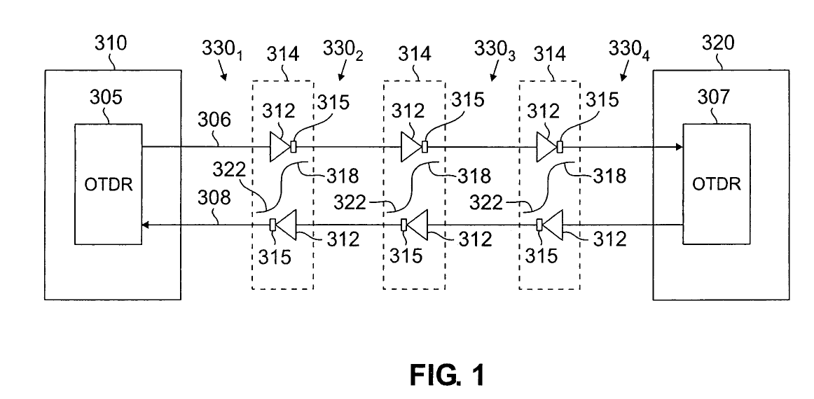

FIG. 1 shows a simplified block diagram of an exemplary regional undersea optical transmission system that employs dense wavelength division multiplexing (DWDM) in accordance with the present invention. The transmission system serves to transmit a plurality of optical channels over a pair of unidirectional optical fibers 306 and 308 between terminals 310 and 320, which are remotely located with respect to one another. Terminals 310 and 320 each include a transmitting and receiving unit (not shown). The transmitting unit generally includes a series of encoders and digital transmitters connected to a wavelength division multiplexer. For each DWDM channel, an encoder is connected to an optical source, which, in turn, is connected to the wavelength division multiplexer. Likewise, the receiving unit includes a series of decoders, digital receivers and a wavelength division demultiplexer. Each terminal 310 and 320 includes a COTDR unit 305 and 307, respectively.

Optical amplifiers 312 are located along the fibers 306 and 308 to amplify the optical signals as they travel along the transmission path. The optical amplifiers may be rare-earth doped optical amplifiers such as erbium doped fiber amplifiers that use erbium as the gain medium. As indicated in FIG. 1, a pair of rare-earth doped optical amplifiers supporting opposite-traveling signals is often housed in a single unit known as a repeater 314. The transmission path comprising optical fibers 306-308 are segmented into transmission spans 330₁-330₄, which are concatenated by the repeaters 314. While only three repeaters 314 are depicted in FIG. 1 for clarity of discussion, it should be understood by those skilled in the art that the present invention finds application in transmission paths of all lengths having many additional (or fewer) sets of such repeaters. Optical isolators 315 are located downstream from the optical amplifiers 220 to eliminate backwards propagating light and to eliminate multiple path interference.

Each repeater 314 includes a coupler arrangement providing an optical path for use by the COTDR. In particular, signals generated by reflection and scattering of the probe signal on fiber 306 between adjacent repeaters enter coupler 318 and are coupled onto the opposite-going fiber 308 via coupler 322. The COTDR signal then travels along with the data on optical fiber 308. COTDR 307 operates in a similar manner to generate COTDR signals that are reflected and scattered on fiber 308 so that they are returned to COTDR 307 along optical fiber 306. The signal arriving back at the COTDR is then used to provide information about the loss characteristics of each span.

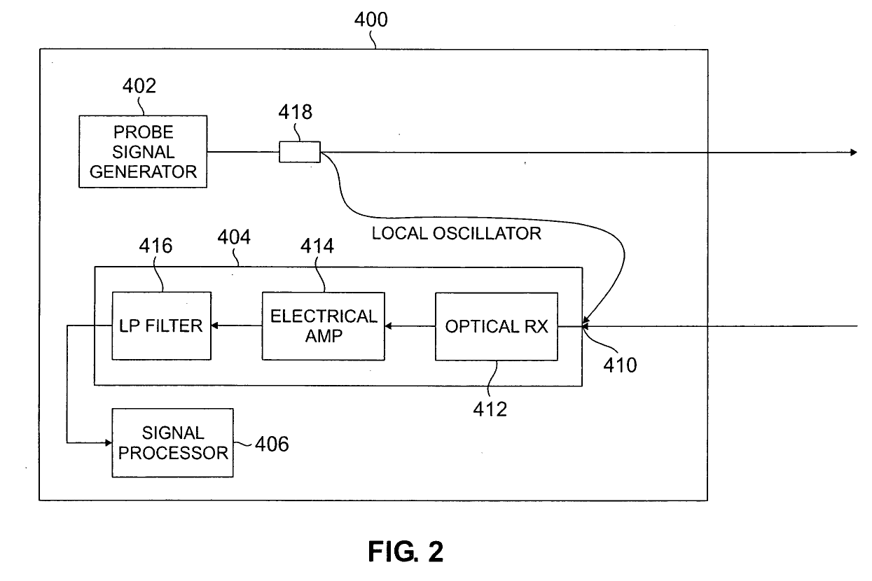

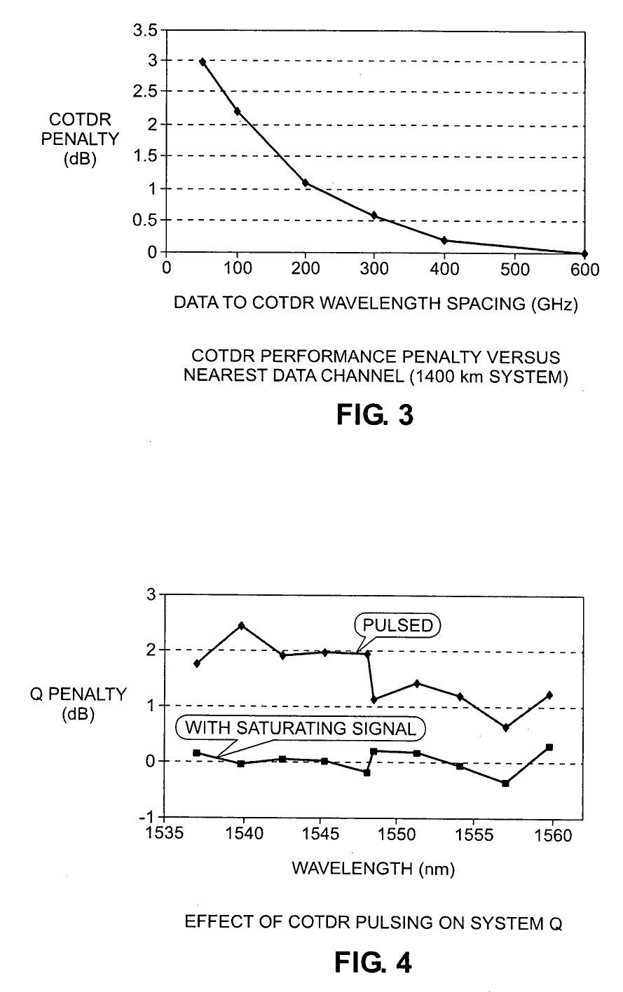

FIG. 2 shows one embodiment of COTDR units 305 and 307. As shown, COTDR unit 400 includes a COTDR probe signal generator 402, an optical homodyne detection type optical receiver 404, and signal processor 406. Optical homodyne detection type optical receiver 404 includes an optical fiber coupler 410, an optical receiver 412, an electrical amplifier 414, and a low pass filter 416. The branch port of the optical fiber coupler 410 and the branch port of the optical fiber coupler 418 are connected to each other.

In operation, the backscattered and reflected COTDR signal received on either optical fiber 306 or 308 (see FIG. 1) is delivered to COTDR 400 and is received by the optical homodyne detection type optical receiver 410. In the optical homodyne detection type optical receiver 410, the backward-scattered probe light is mixed by the optical fiber coupler 410 with an oscillating light branched from the probe signal generator 402 by the optical fiber coupler 418, subjected to square-law detection by the optical receiver 412, and converted into a baseband signal having intensity information on the probe pulses. The photoelectrically converted baseband signal deriving from the probe signal is amplified by the electrical amplifier 414, and reduced of its noise content by the low pass filter 416. Then the signal processor 406 computes the reflecting position of the probe signal on the optical fiber from the arrival time of the homodyne detection signal and the loss characteristic of the optical fiber from the level of the homodyne detection signal. The method of measuring the optical fibers using the probe light signal is that of the optical time domain reflectometer (COTDR) by a coherent method.

Turning now degradations to the COTDR signal, since the COTDR signal is coherently detected at the receiver and passed through a narrowband electrical filter, spectral broadening due to nonlinear interactions with the signal channels (i.e. traffic) will cause an apparent weakening of the COTDR signal. The most serious degradation of the COTDR signal comes from cross phase modulation (XPM) whereby the signal channels induce phase modulation on the COTDR signal. As shown in Ting-Kuang Chiang, et al., “Cross-Phase Modulation in Dispersive Fibers: theoretical and Experimental Investigation of the Impact of Modulation Frequency”, IEEE Photonics Technology Letters 6, 1994, the induced phase Δφ_{XPM}, can be written to explicitly show the dependence on wavelength separation, Δλ, of the interfering channels.

$${Δϕ}_{XPM} ∝ {Δϕ}_{0} ( P , L ) \cdot \sqrt{\frac{{α}^{2}}{{α}^{2} + {( Ω D Δλ )}^{2}}} \qquad ( 1 )$$

Here α is the fiber loss, D is the dispersion, Ω is the modulation rate of the interfering signals, and Δφ₀ is the component of the induced phase that depends on the power P, of the interfering channels and the system length L. Using this relationship, the required guard band required between the COTDR signal and the DWDM signals can be estimated. Notice that increasing the dispersion or the guard band (Δλ) will reduce the cross phase modulation penalty, and increasing the signal power or the system length will increase the penalty.

FIG. 1 shows the measured COTDR signal penalty as a function of the guard band to the nearest DWDM signals for a 1400 km system. For systems of 1000-2000 km, a guard band of 200 GHz spacing is sufficient, and for longer systems larger guard bands would be required.

Turning now to degradations in the DWDM signal channels, the COTDR signal degrades the DWDM signals through reduction of the optical signal-to-noise ratio, gain modulation effects, and nonlinear interactions.

The addition of the COTDR signal effectively reduces the total power available to the DWDM signals and hence causes an OSNR penalty. Measurements show that quite modest COTDR powers are sufficient and this penalty will therefore be small.

The nonlinear degradations of the DWDM signal channels caused by the COTDR signal is much smaller than that of the COTDR caused by the presence of nearby DWDM signals. This is because the coherent detection used by the COTDR is much more sensitive to non-linear phase distortions than the direct detection methods used for the DWDM signals.

The gain modulation effect can be quite serious, and increases with system length. This occurs because the pulsed COTDR signal in the outbound path modulates the gain of the EDFA amplifiers. Reducing the COTDR signal level can control the degradation. Unfortunately this only works for shorter systems (<1000 km) where less COTDR power is required. For longer systems, it is necessary to use methods that eliminate the COTDR gain modulation.

FIG. 2 shows the mean Q penalty per DWDM channel caused by the COTDR signal for a pulsed COTDR, and a COTDR with a saturating signal that eliminates the gain modulation. The results shown below are for an 850 km system.

These results show that the pulsed COTDR causes significant penalties to the DWDM service channels. For this case, in-service monitoring using the COTDR could not be used unless the COTDR power was lowered. When a saturating signal is included, the gain modulation effects from the pulsed COTDR go away and system penalties due to in-service COTDR operation are negligible.

1. A method of obtaining status information concerning an optical transmission path, said method comprising the steps of:
generating a COTDR probe signal having prescribed wavelength;
transmitting optical traffic signals and the COTDR probe signal over an optical transmission path having a length corresponding to those used in regional undersea market applications, wherein the prescribed wavelength of the COTDR probe signal is separated from wavelengths at which the optical traffic signals are located by a distance at least equal to a predetermined guard band;
receiving over the optical path a backscattered and/or reflected portion of the COTDR probe signal in which status information concerning the optical path is embodied; and
detecting said backscattered and/or reflected portion of the COTDR probe signal to obtain the status information.

2. The method of claim 1 wherein said length of the optical transmission path is less than about 5,000 km.

3. The method of claim 1 wherein said predetermined guard band is equal to or greater than about 200 GHz.

4. The method of claim 1 wherein said COTDR probe signal is a pulsed signal.

5. The method of claim 1 wherein said COTDR probe signal includes a saturating signal to reduce gain modulation.

6. The method of claim 4 wherein the traffic signals are located at one or more wavelengths sufficiently remote from a waveband occupied by the cw probe signal to reduce FWM and XPM so that both the quality of the optical traffic signals and COTDR sensitivity are maintained at acceptable levels.

7. The method of claim 1 wherein said transmission path includes at least one optical amplifier located therein.

8. A method of using COTDR with a bi-directional optical transmission system that includes first and second terminals interconnected by at least first and second unidirectional optical transmission paths having at least one repeater therein, said method comprising the steps of:
generating a COTDR probe signal having prescribed wavelength;
transmitting optical traffic signals and the COTDR probe signal over the first optical transmission path, said first and second optical transmission paths each having a length corresponding to those used in regional undersea market applications, wherein the prescribed wavelength of the COTDR probe signal is separated from wavelengths at which the optical traffic signals are located by a distance at least equal to a predetermined guard band;
receiving over the second optical path a backscattered and/or reflected portion of the COTDR probe signal in which status information concerning the first optical path is embodied; and
detecting said backscattered and/or reflected portion of the COTDR probe signal to obtain the status information.

9. The method of claim 8 wherein said at least one repeater includes a rare-earth doped optical amplifier through which the optical probe signal is transmitted.

10. The method of claim 8 further comprising the step of transmitting the returned COTDR signals from the first optical path to the second optical path over an optical loopback path.

11. The method of claim 10 wherein said optical loopback path is located in said repeater.

12. The method of claim 8 wherein the status information includes discontinuities in the first optical path that gives rise to optical attenuation.

13. The method of claim 8 wherein said length of the optical transmission path is less than about 5,000 km.

14. The method of claim 8 wherein said predetermined guard band is equal to or greater than about 200 GHz.

15. The method of claim 8 wherein said COTDR probe signal is a pulsed signal.

16. The method of claim 8 wherein said COTDR probe signal includes a saturating signal to reduce gain modulation.
